(19) United States
(12) Patent Application Publication
(10) Pub. No.: US 2025/0348521 A1
(43) Pub. Date: Nov. 13, 2025

(54) Memory Assistant System

(71) Applicant: Massachusetts Institute of Technology, Cambridge, MA (US)

(72) Inventors: Wazeer ZULFIKAR, Cambridge, MA (US); Wei Ting Samantha CHAN, Cambridge, MA (US); Pattie MAES, Cambridge, MA (US)

(73) Assignee: Massachusetts Institute of Technology, Cambridge, MA (US)

(21) Appl. No.: 19/204,840

(22) Filed: May 12, 2025

Related U.S. Application Data
(60) Provisional application No. 63/645,327, filed on May 10, 2024.

(51) Int. Cl. G06F 16/3329; G10L 15/183

(52) U.S. Cl. CPC G06F 16/33295; G10L 15/183

(57) ABSTRACT

In one aspect, a system for context-based query modeling is provided. The system includes an input device to provide a textual representation of speech. The system also includes a memory encoder for generating encoded speech data structures based on the textual representation of speech. The system also includes a query agent for generating a query-context speech data structure encoding a segment of the textual representation of speech. The system also includes a retrieval agent for generating a response based on the query-context speech data structure and the encoded speech data structures. The response defines a reply to the inferred query. The system also includes an output device for presenting the response.

### CROSS-REFERENCE TO RELATED APPLICATIONS

This application claims the benefit of U.S. Provisional Application No. 63/645,327, filed May 10, 2024, and hereby incorporated by reference in its entirety.

### STATEMENT REGARDING FEDERALLY SPONSORED RESEARCH N/A.

### BACKGROUND

People have to remember an ever-expanding volume of information. Wearables that use information capture and retrieval for memory augmentation can be disruptive and cumbersome in real-world tasks, such as in social settings.

Memory plays an essential role in people's lives, whether in communication, learning, decision-making, or maintaining relationships. However, memory is imperfect and error-prone due to factors such as lack of sleep, stress, and divided attention. Furthermore, neurological disorders related to memory loss, such as dementia, are rising as populations in many parts of the world grow older.

Memory augmentation and information retrieval systems have been of key interest to the human-computer interaction (HCI) community as tools to address these growing challenges. There has been extensive work on systems and devices to extend our memory such as lifelogging systems that continuously record the user's media and signals, and just-in-time information retrieval systems that provide relevant information based on the user's context. While these wearable systems demonstrate the capabilities of users to retrieve vast amounts of information, limited research exists on designing interfaces that enable the retrieval of information in a minimally disruptive way when the user is already engaged in a primary task, which is often the case with wearables.

Wearable memory augmentation has been a well-researched area since the 1990s when Mik Lamming coined the term “memory prosthesis.” Since then, there have been various forms of memory augmentation systems, including reminder systems and lifelogging systems. Lifelogging devices continuously capture signals such as audio, video, and biosignals resulting in a vast store of data. In the audio domain, a personal audio memory aid can record information and allow the user to search it using keywords. A personal audio loop (PAL) may be a ubiquitous service to recover audio content. Audio lifelogs may be recorded using wearable microphones and experimented with different ways of browsing these lifelogs through a smartphone application. However, such types of browsing and keyword querying of audio data require a screen and, hence, use the users' visual focus and time to read the information provided. One factor in the acceptance of wearables in memory augmentation is the case of use. However, traditional memory augmentation devices were not designed to have quick and seamless interactions where disruption time during usage is critical, such as in conversations or driving.

### SUMMARY

Disclosed herein are embodiments of a memory assistant system and related techniques that can address the above problems and provide other advantages. In some embodiments, the memory assistant is audio-based, meaning that it takes audio input and provides audio output, although other modalities are also described herein. The memory assistant system uses a large language model (LLM) to infer the user's memory needs in a conversational context, semantically search memories, and present suggestions (e.g., minimal suggestions). The assistant can have two interaction modes: query mode for voicing queries and queryless mode for on-demand predictive assistance, without explicit query. The assistant can reduce device interaction time and increase recall confidence while preserving conversational quality. Disclosed memory augmentation systems may be described as minimally disruptive, meaning that they reduce and ideally avoid interruption of the on-going conversation.

Some embodiments provide an audio-based memory assistant with a concise user interface. The memory assistant continuously listens to the surrounding audio and encodes the raw speech transcriptions in memory, tagged by the timestamp at which the raw speech was transcribed and stored locally in the device. Whenever the user has a real-time request for retrieval of information, they can trigger the system by pressing a ring button. The button informs the system that the user has a memory request. The button push can trigger one of two interaction modes: query mode and queryless mode.

In queryless mode, the user can explicitly query the memory assistant system using natural language speech. If the user is in an on-going conversation, the user can ask a brief question related to the conversation as the system is continuously listening, thus giving it conversational contextual awareness. For example, if the user is talking to a supermarket attendant and has said “I have bought eggs and bread” in the conversation and wishes to remember the third thing they intended to purchase, they can hold a trigger button for queryless mode while asking “What was the third thing?”. The memory assistant system can then retrieve the answer, “Bananas”, from the previously recorded memories. The retrieved answer is converted to audio using text-to-speech and played to the user, for example, through a bone-conduction headset.

In queryless mode, the user can also request predictive assistance, such that the system infers the information that the user requests based on the current context and delivers the response without any explicit query from the user, similar to an autocomplete functionality. With the same example as above, after saying “I have bought eggs and bread but need to buy . . . ”, the user could trigger the queryless mode for the system by pressing the button which, based on understanding of the conversational context, infers the query, and respond with the suggestion “Bananas” for the user to integrate into their incomplete sentence.

In one aspect, a system for context-based query modeling is provided. The system includes an input device to provide a textual representation of speech. The system also includes a memory encoder for generating encoded speech vectors based on the textual representation of speech. The system also includes a query agent for generating a query-context speech vector encoding a segment of the textual representation of speech. The system also includes a retrieval agent for generating a response vector based on the query-context speech vector and the encoded speech vectors. The response vector defines a response to the inferred query and provides a reply. The system also includes an output device for presenting the response.

In one aspect, a system for context-based query modeling is provided. The system includes an input device to provide a textual representation of speech. The system also includes a memory encoder for generating encoded speech data structures based on the textual representation of speech. A query agent is included for generating a query-context speech data structure encoding a segment of the textual representation of speech. A retrieval agent for generating a response based on the query-context speech data structure and the encoded speech data structures is also included. The response defines a reply to the query-context speech data structure. The system also includes an output device for presenting the response.

In a further embodiment of the system above, the input device includes a microphone to generate audio data responsive to the speech and/or a speech-to-text converter to generate the textual representation of the speech from the audio data.

In another embodiment of any one of the systems above, the input device is configured to detect a conversation has begun and, in response to the conversation having begun, to generate audio data responsive to the speech in the conversation.

In a further embodiment of any one of the systems above, the input device is configured to detect the conversation has ended and, in response to the conversation having ended, to cease generating audio data.

In another embodiment of any one of the systems above, the output device includes a text-to-speech converter to generate audio data encoding the response, and a device for converting the audio data to sound. The device for converting the audio data to sound may be a bone conduction device, an earpiece and/or a speaker, e.g., a cell phone speaker.

In a further embodiment of any one of the systems above, the system is configured to convert the response to a text message. The output device may also include a display configured to show the text message.

In another embodiment of any one of the systems above, the system also includes a current context buffer configured to store a threshold number of recent encoded speech data structures. The query agent can generate the query-context speech data structure encoding based at least in part on the recent encoded speech data structures stored in the current context buffer.

In an additional aspect, a method for context-based query modeling is provided. The method includes monitoring a conversation that has speech data by applying a first large language model to generate encoded speech data structures. The method also includes receiving a trigger requesting a response to an inferred query and applying, by a query agent, a second large language model to a segment of speech captured prior to receiving the trigger to generate a query-context speech data structure. A third large language model is applied by a retrieval agent to the query-context speech data structure and the encoded speech data structures in order to generate a response. The response defines the response to the inferred query. The method also includes generating an output based on the response and presenting the output.

In a further embodiment of the method above, presenting the output includes displaying a text response message on a phone screen, a smart watch screen, and/or a smart glasses display.

In another embodiment of any one of the methods above, the method also includes applying a text-to-speech converter to the response in order to generate an audio response message. Presenting the output can include playing the audio response message on a phone speaker, a smart watch speaker, an earpiece and/or bone conduction headset.

In a further embodiment of any one of the methods above, applying the third large language model to generate a response includes applying the third large language model to historic encoded speech data structures. The historic encoded speech data structures include data structures generated from speech captured in a prior conversation.

In another embodiment of any one of the methods above, the method also includes collecting context data by determining a location of the conversation and/or a time of day of the conversation. Applying the third large language model to generate a response can also include applying the third large language model to the context data.

In a further embodiment of any one of the methods above, the method also includes collecting physiological data of a speaker in the conversation by determining a heart rate and/or blood oxygen levels of a user. Applying the third large language model to generate a response can also include applying the third large language model to the physiological data.

In another embodiment of any one of the methods above, the trigger is a command word and/or a button press, for example, on a ring button device.

In a further embodiment of any one of the methods above, the segment of speech captured prior to receiving the trigger includes a sentence fragment. The response completes the sentence fragment.

In another embodiment of any one of the methods above the segment of speech captured prior to receiving the trigger includes a question. The response answers the question.

In a further embodiment of any one of the methods above, the method also includes processing the response to remove any words found in the segment of speech captured prior to receiving the trigger.

In another embodiment of any one of the methods above, the conversation is a text-based exchange, and the speech data is string of text from the text-based exchange.

### BRIEF DESCRIPTION OF THE DRAWINGS

The foregoing features may be more fully understood from the following description of the drawings in which various aspects of the concepts and embodiments described herein are described. It should be appreciated the figures are not necessarily drawn to scale. In the drawings, each identical or nearly identical component that is illustrated in various figures is represented by a like numeral. For purposes of clarity, not every component may be labeled in every drawing.

FIG. 1 is a block diagram showing a memory assistant system, according to some embodiments.

FIG. 2A is a block diagram showing interactions between components of a memory assistant system, according to some embodiments.

FIG. 2B is another block diagram showing interactions between components of a memory assistant system, according to other embodiments.

FIG. 3 is another block diagram showing a detailed workflow of components of a memory assistant system, according to further embodiments.

FIG. 4 is a flow diagram that illustrates a method for providing a response to a request for information using a memory assistant system, which method can be implemented and executed as computer program instructions, in accordance with various embodiments.

FIG. 5 is a block diagram illustrating selective components of an example computing device in which various aspects of the disclosure may be implemented, in accordance with an embodiment of the present disclosure.

### DETAILED DESCRIPTION

Various embodiments provide a minimally disruptive wearable assistant (e.g., audio-based assistant) that uses LLMs to aid the user in retrieving relevant information from previously recorded personal data and provide concise suggestions. The memory assistant can continuously transcribe and encode audio data from conversations the user engages in. The memory assistant can have two modes of interaction for retrieval: queryless mode, where the user voices their natural language query, and queryless mode where the user is presented with a suggestion relevant to the current conversational context without having to explicitly query the system. In either mode, the memory assistant can provide concise memory responses to the user. In some embodiments, the memory assistant can use a lightweight, bone-conduction headset for unobstructed and private responses, although other hardware and modalities are disclosed.

The system may be used regularly by a user to record and store information gathered, for example, from conversations with others. During the conversation, the system records and encodes the speech. The encoded speech may be stored as an encoded memory.

The system may be configured to monitor speech around the user. The system can detect when a conversation has begun, for example, when the user speaks, anyone speaks near the user (e.g., with sufficient volume), when the user accepts a phone call, etc. Likewise, the system may detect when the conversation has ended. For example, the system can automatically detect an end of a conversation if no new speech is detected for more than a predetermined period. As another example, the system can detect an end of a conversation if a participant says one of a set of predetermined conversation-ending words, such as “goodbye.” As another example, the system can detect an end of a conversation when a phone call has ended. Various other approaches can be used to detect an end of a conversation.

The system can assign a unique identifier (ID) to each speaker in the conversation. This may be done during the conversation (e.g., in real-time) or after the conversation. The ID may be assigned based on voice print or other distinguishing features (e.g., volume, direction, etc.). The user's voice features may be determined and used to identify the user's speech. For example, the user may perform a configuration process during set-up where the system establishes the criteria used to identify the user's speech. The system may also assign an ID for its own ‘speech’.

Additionally, the system may encode memory based on input other than speech. Any input that can be converted to text may be used. For example, the system may monitor a text exchange, emails, etc. In some embodiments, the system may include a camera to recognize text in view of the user, such as with smart glasses, for example, to read hand-written notes, labels or price tags.

When the user attempts to recall a piece of data, for example, in real-time during an on-going conversation, they may provide a request to the memory assistant system. The user can trigger the system to respond to a queryless mode request, for example, system by pressing a specific button which instructs the system to infer the query based on the current conversational context and respond with the appropriate response. In one such example, the user can speak an incomplete sentence: “I have bought eggs and bread but need to buy . . . ” and the system response with a suggestion: “Bananas” which the user can then use to integrate into their incomplete sentence and finish their statement.

Alternatively, the request may be a query mode request for information, for example, a question asking for the data.

The memory assistant system analyzes the request (whether a queryless mode request or a query mode request) and uses stored information to answer the request and presents a response to the user. The response may be provided in a manner that avoids interruption of the on-going conversation. Use of such a memory assistant system can increase the user's recall confidence while preserving conversational quality.

Voice interfaces can enable users to maintain high face focus and eye contact during conversations. Therefore, various embodiments provide a voice-based retrieval approach for an audio-based wearable memory assistant that can handle natural language queries with a focus on minimizing disruption to the primary task of the user. With concise responses from the assistant serving as memory suggestions, device interaction time is reduced and the quality of the primary task while using the system is preserved. Additionally, when the user is trying to retrieve specific details, users can skip having to form an explicit query by having the assistant infer their memory retrieval query based on the current context.

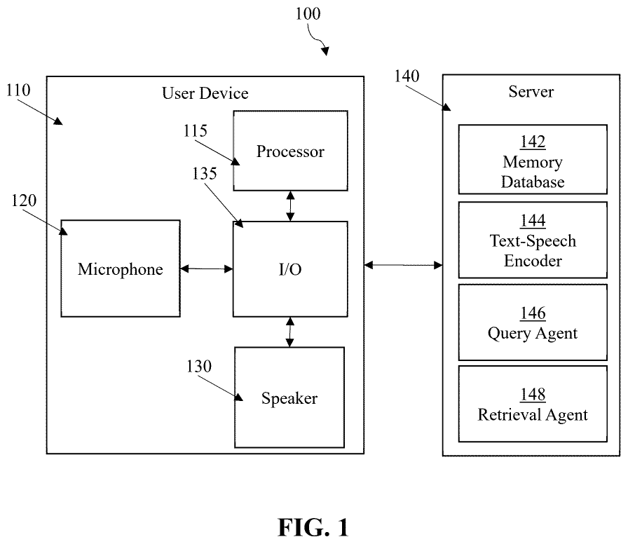

FIG. 1 is a block diagram showing various devices suitable for practicing various embodiments. A system 100 includes a user device 110-for example, a smartphone, tablet, headset, smart watch, or other wearable computing device-which provides or is connected to one or more input-output (I/O) devices, for example, a microphone 120 and a speaker 130. The microphone 120 and speaker 130 may be embodied in the user device 110. Alternatively, one or more of the microphone 120 and speaker 130 may be separate from the user device 110, for example, the speaker 130 may be a bone conduction headset, an earpiece, etc. The user device 110 may also include additional input/output (I/O) devices, such as a wearable ring trigger, a screen, smart glasses, etc.

The user device 110 includes a processor 115 that provides a memory augmentation interface, for example, a memory assistant interface, for a user which they can interact with and receive responses. The processor 115 may use an I/O layer 135 to operate the various I/O devices, for example, the microphone 120 and/or the speaker 130, in order to interact with and receive responses from the user. The I/O layer 135 may provide drivers which control the various I/O devices.

In some embodiments, microphone 120 and/or speaker 130 may be provided within a bone conduction headset that communicates with the processor 115. In such embodiments, speaker 130 can provide the user a parallel channel of audio allowing the user to have conversations with people while being able to hear audio responses from a memory assistant interface without impeding their field of view. Microphone 120 can be an in-built microphone of a bone conduction headset.

In some embodiments, user device 110 (or, more particularly, the memory assistant interface provided therein) communicates with a server 140 to enable various functions, for example, processing, data storage, etc. The user device 110 may communicate with the server 140, for example, via one or more wireless or wired network connections. In some embodiments, user device 110 may communicate with server 140 through the Internet. In some embodiments, the user device 110 may send speech messages recorded by the microphone 120 to the server 140. The server 140 includes a memory database 142 and a text-speech encoder 144. The text-speech encoder 144 may be used to encode speech messages received from the user device 110 as encoded memories. The server 140 may then store the encoded memories in the memory database 142. Encoded speech may be represented as a combination of vectors, raw transcribed sentences, and/or metadata associated with the speech (such as, who spoke, time, location, etc.).

In other embodiments, the user device 110 may include a local text-speech encoder and send encoded memories to the server 140. Additionally, the user device 110 may encrypt the encoded memories or speech messages before transmission.

Similarly, in some embodiments the user device 110 may provide some or all of the functionality described. Where the user device 110 performs all functions locally, the server 140 may be eliminated.

The server 140 includes a query agent 146. The query agent 146 may provide encoded speech as an input to a language model (LLM) (or “apply” the LLM to the encoded speech) in order to identify a request for information, a query. In some examples, encoded speech may correspond to a segment of a conversation. This request may be determined from a recent question, an incomplete sentence, or another cue. The query agent 146 may also allow the LLM to consider encoded memories, for example, recent encoded memories from an ongoing conversation. The query may be an inferred request determined from the context of conversation. The LLM may be part of system 100 or external thereto. In some embodiments, query agent 146 can use an application programming interface (API) to interact with the LLM, for example, to provide a prompt for the LLM.

The prompt for the LLM may include the inferred query and/or any additional information from encoded memories to help understand the query. The prompt may also provide details regarding the response, e.g., hard-coded information, such as the desired format of the answer; instructions to the LLM providing a goal of the response, such as to answer the question using memories, etc.

The server 140 includes a retrieval agent 148. The retrieval agent 148 may apply an LLM to the query and encoded memories in order to generate a response. The retrieval agent 148 generates a prompt for the LLM that contains instructions on how to search the database of encoded memories. These instructions may include details such as semantic information (e.g., a cue), a time, a location and a speaker. This information can be used by the LLM to filter the database in order to return the most relevant encoded memories from the database. The time of the relevant memories can also be used to prioritize the memories so as to emphasize more recent memories. The returned memories can then be used along with the inferred query by an LLM to answer the question presented in the query using the relevant memories and respond to the user.

The LLM used for the retrieval agent 148 may be the same LLM used by the query agent 146 or it may be a different LLM. The response may be provided to the user device 110, for example, as text, or provided converted into speech by the text-speech encoder 144 before being sent to the user device 110.

Minimal disruption for a memory augmentation interface, such as system 100, is defined as (1) requiring minimal input from the user to request information, i.e., the input the user gives is short, and (2) providing minimal output, namely the suggestion or response provided by the augmentation system is the smallest amount of information that will give the user the information they need. The minimal disruption design consideration enables the usability of wearable memory augmentation systems, especially in social settings that are attention-demanding and where incidentally the highest number of memory lapses occur, such as conversations.

Therefore, system 100 is a seamless, user-friendly, and concise search interface to keep disruption to the user's primary task minimal. Incorporating context awareness reduces or even completely eliminates the query input, allowing users to skip posing an explicit, comprehensive retrieval query, as system 100 can directly infer the user's specific memory needs. Query agent 146 and/or retrieval agent 148 can use large language models (LLMs) to understand conversational context in natural settings and enable more flexible search queries using alternative phrases. The LLMs also enable the shortening of answers for succinct suggestions. This leverages LLMs to create easy-to-use and minimally disruptive interfaces.

Social interactions, such as, during conversations, are a setting in which many subjective memory complaints occur. The system 100 can provide a means for fluid transition and re-engagement to case the switch between information retrieval and the conversation. Accordingly, system 100 can reduce query time and response duration. For example, the system 100 can speed up the retrieval process by proactively retrieving relevant information from the memory database 142 based on the user's current context.

Rather than providing proactive support, an on-demand suggestion interface can be less distracting to the user experience. The system 100 can minimize disruptions to reduce users' explicit awareness of the system. This can decrease the user's cognitive load and increase the sense of agency and sense of body-ownership. On-demand predictive assistance can be provided through the queryless mode.

The language of voice queries is closer to natural language than typed queries. Query agent 146 and/or retrieval agent 148 take advantage of recent advances in natural language processing, particularly the development of LLMs. With the integration of language models, users can interact with systems using natural language. They can provide flexibility in user queries for different language use, such as synonyms, and alternative phrasings, and can compensate for inaccurate voice transcription due to the prerecorded priors. This capacity is attributed to the use of LLMs by the query agent 146 and/or retrieval agent 148 to comprehend intentions and generate natural language in a contextualized manner.

Further, vectorized embeddings of text generated by the LLMs facilitate semantic search which enables diverse queries. For instance, while the recorded memory can be “He likes to hike and jog”, a successful natural language voice query can be “What are his outdoor hobbies?”, which has zero keyword matches. Furthermore, LLMs are adept at summarization tasks aiding in providing minimal output to users in the concise interface. Hence, query agent 146 and/or retrieval agent 148 leverage the capabilities of LLMs to power flexible searches through memories and to interact with a voice-based assistant.

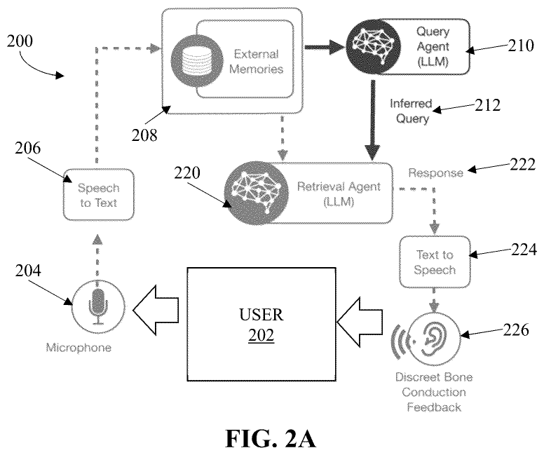

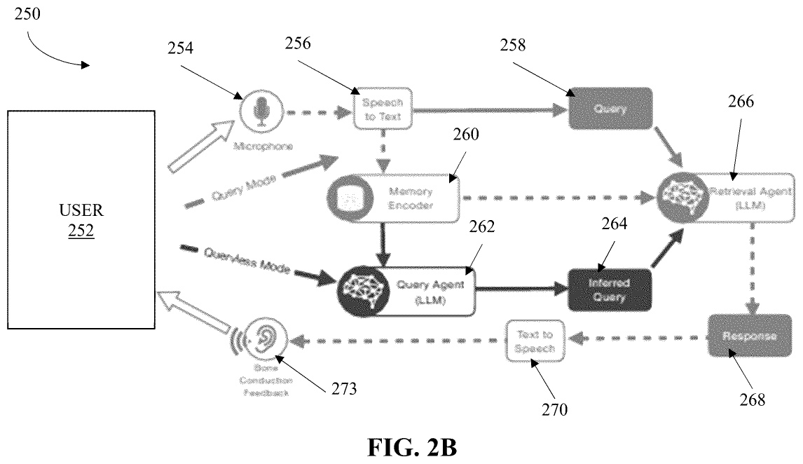

FIG. 2A shows interactions between components of a memory assistant system 200, according to some embodiments. Illustrative system 200 includes an input device, such as a microphone 204, a speech-to-text module 206, a memory database 208, a query agent module 210, a retrieval agent module 220, a text-to-speech module 224, and an output device, such as a discreet bone conduction feedback device 226.

A user 202 interacts with the input device, for example, using microphone 204 to record a conversation involving the user 202. The speech is analyzed by a speech-to-text module 206 to parse the speech and convert the speech into a searchable data structure, such as text or a vector representation of the speech. The data structure is then provided to a memory database 208 where it can be stored as an external memory.

If the speech is determined to be a request for information, for example, by receiving a trigger input or detecting a keyword in the speech, the request is provided to a query agent module 210 (either directly or after storing in the memory database 208. The query agent module 210 uses an LLM to analyze the request to create an inferred query 212. A retrieval agent module 220 applies an LLM to the inferred query 212 and external memories in the memory database 208 in order to generate a response 222. The response 222 is passed to a text-to-speech module 224 where the response 222 is converted into an audio output that can be played on an output device. The output device may be an audio output device, such as, a discreet bone conduction feedback device 226, a speaker, an earpiece, etc. In other embodiments, the output may be text shown on a screen, a smart glasses display, etc.

FIG. 2B is a schematic diagram showing a system 250 for another operation of a response, according to other embodiments. In this operation, the user 252 uses a microphone 254 to record a conversation involving the user 252. The conversation is provided to a speech-to-text module 256 that parses the conversation into segments, for example, into discrete sentences, and converts the conversation segments to text (or another representative data structure). The text is provided to a memory encoder 260 which can encode the text into a memory data structure, e.g., a vector representing the text.

The memory encoder 260 may be continuously updated using speech-to-text module 256. The system 250 can be configured to use query or queryless mode. In the queryless mode, the explicit query is voiced by the user 252, while in the queryless mode, the system 250 infers the query.

When operating in query mode, the system 250 interprets the text as a direct request for information-a query 258. In query mode, the query 258 is passed to the retrieval agent LLM 266. The system 250 may receive a trigger from the user 252 indicating the user's input as a request for information, such as a button press, a spoken keyword, etc.

The system 250 may instead operate in a queryless mode where the text is an indirect request which does not explicitly specify the information being sought by the user. In the queryless mode, the indirect request is provided to a query agent LLM 262 which interprets the request in order to generate an inferred query 264. The interpretation may analyze the indirect request and may consider additional memory data structures, such as recent segments in an ongoing conversation. The inferred query 264 may then be passed to the retrieval agent LLM 266.

The retrieval agent LLM 266 operates on the query 258 or the inferred query 264, depending on the mode, and stored memory data structures to generate a response 268. The response 268 is intended to provide an answer to the request (either direct or indirect), for example, the information being sought.

Once the response 268 is generated, the response 268 is passed to a text-to-speech process 270. The text-to-speech process 270 creates an audio data file which can be played by the bone conduction feedback device 273 for the user 252 to hear. In other embodiments, an earpiece or speaker may be used to play the audio data file.

Auditory memories can be stored using a two-step process. A continuous transcription is run on what the microphone picks up, including both the speech of the user and any conversation partners. The transcription may be first stored as a current context of the conversation. The current context is maintained in a fixed-sized buffer having a buffer threshold of characters of data, for example, the last 75 characters in order to capture the most recent couple of sentences in the conversation; however, a larger buffer threshold may be used to capture additional context.

The buffer is continuously updated by adding new information and removing information that is beyond the buffer threshold. The set of information removed from the current context may be chunked together into a single block and encoded into the external memories as a memory.

Encoding of the memory can be done using sentence embedding vectors of the text transcription of the full block. The embeddings capture the meaning of the memory enabling semantic search beyond keyword matching. Embeddings can be calculated using a pre-trained sentence transformer model which maps sentences and paragraphs to a vector space (e.g., a 384-dimensional dense vector space). Through these embeddings, semantically relevant memories containing the answer to the user query can be selected during retrieval. The embeddings, the text transcription, and the start timestamp for each memory block are stored using a vector database for faster retrieval.

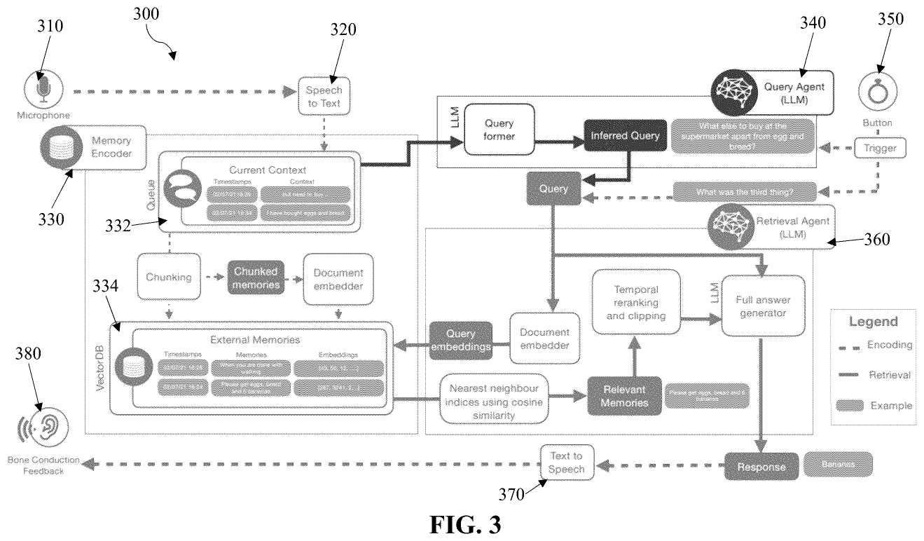

FIG. 3 is a schematic diagram showing a different operation of a response, according to further embodiments. The system 300 includes a microphone 310 which gathers conversation speech and sends the speech to a speech to text process 320. The speech-to-text process 320 converts the speech to text and provides the speech transcriptions to a memory encoder 330.

The memory encoder 330 takes speech transcriptions and maintains the current context in a queue 332 (e.g., a current context buffer). The speech transcriptions may be stored with timestamps, as well as other information, such as location data (e.g., GPS data obtained from a wearable device). Once the speech transcriptions fill the queue 332, the speech transcriptions may be further processed, e.g., chunked together and/or processed with embeddings. The speech transcriptions are then stored in the vector database 334 as external memories.

In some embodiments, the current context may also include user details such as present condition, e.g., heart rate, blood pressure, etc., and recent activity, e.g., waking up, running, etc. Additional information can also be added, such as participants in a conversation, identification of who spoke, etc. These details may also be stored with the speech transcriptions.

When the system 300 receives a query, for example, from a button 350 press providing a trigger, the current context is provided to the query agent 340, such as an LLM. The query agent 340 takes in the context and produces an inferred query (in queryless mode). If the current context includes a direct question, the question may be provided as the query (in query mode).

To increase case of use and reduce input to the memory assistant, queries from the user can be shortened using contextual awareness. As the memory assistant continuously tracks the context of the ongoing flow of the conversation, the user can query the memory assistant with questions that build on this flow for a less disruptive interaction. For instance, if a user is saying the following sentence, “John teaches science, math and . . . ”, and wishes to recall the third subject that John teaches, with context awareness of the assistant, the user could directly query “What else?” as opposed to having to formulate the full context-unaware query “What is the subject that John teaches other than science and math?”.

A retrieval agent 360 takes the query and responds with a concise answer from the user's encoded external memories in the vector database 334. The retrieval agent 360 can use a document embedder to generate query embeddings which are passed to the vector database 334 in order to identify relevant memories.

In some embodiments, the contextual search begins when the user voices a natural language query to the memory assistant. The query and the current context containing the most recent conversation are combined to retrieve relevant external memories from the vector database 334. The vector embeddings for the query and current context, which are concatenated, are calculated using the same embeddings model used in the memory encoder. These vector embeddings are used to search for the most semantically similar external memories by comparing them to the stored embeddings of the external memories which are pre-calculated during the encoding process. The comparison uses a nearest neighbor search with a cosine score as the similarity measure. The text transcriptions of similar external memories constitute the relevant memories for the contextual search. The relevant memories are reordered based on ascending timestamps to form temporally linear memories and then clipped to a token limit (e.g., 4096 tokens) of the large language model.

The query, current context, and retrieved relevant memories are combined to form a prompt for the text generation language model. The prompt uses a combination of explicit and structured prompt engineering. Explicit prompts directly request the LLM to generate an answer to the user query from the relevant memories, while the structured aspect uses a template to guide the generation to a parse-able form. The prompt is designed to be able to search through relevant memories and generate the answer.

Once the answer has been retrieved, the answer is further post-processed to be more concise to minimize response duration and reduce output from the assistant. Searching through external memories, rather than sifting through new information, allows for further conciseness. For instance, “Her name is Sarah” can be replaced with “Sarah”. Therefore, any extraneous words such as connectives that do not address the question may be eliminated.

Further, contextual compression may be used to remove any words that have already been retrieved by the user, either in the query or in the current conversational context. For instance, with the current context as “She is an engineer” the query “What was her name and what is her specialization?” and the generated answer “Her name is Emily and she works as a Software Engineer” gets compressed to “Emily, Software”.

Addressing the query from the user, the answers can be shortened to specifically what is requested to complete the user's query. The conciseness and redundancy removal may be implemented by passing the query, current context, and the generated answer from the previous run to the retrieval agent with a template prompt that instructs the language model appropriately.

The queryless mode enables the user to receive on-demand predictive assistance without having to explicitly form a query. This is facilitated by the user requesting the memory assistant to understand the ongoing flow of the conversation and infer their precise memory request. For example, if the user is already saying “He likes to play Settlers of Catan, Pandemic and . . . ”, and then triggers the assistant, the query agent can predict the user query “What is the third board game he likes?” allowing the user to skip query formation. The query agent 340 infers the query that the user is likely to ask based on a current context. The question inference prompts the language model to produce an inferred query. The inferred query is then passed to the retrieval agent 360. This queryless mode feature minimizes the time spent in interactions during conversations, making the system 300 more efficient and user-friendly.

Returning to FIG. 3, the response generated by the retrieval agent 360 is then provided to a text-to-speech process 370 where it is converted to speech. The speech is played by a bone conduction feedback device 380.

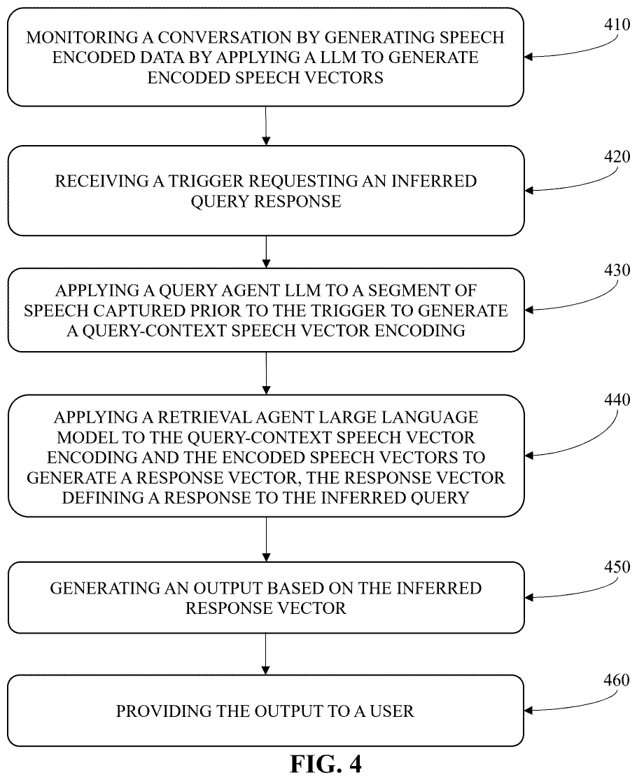

FIG. 4 is a logic flow diagram illustrating a method, and a result of execution of computer program instructions embodied on a memory, in accordance with an embodiment. The method includes, at Block 410, monitoring a conversation by generating speech data by applying a large language model (LLM) to generate encoded speech vectors. A trigger requesting an inferred query response is received at Block 420. The method also includes, at Block 430, applying a query agent LLM to a segment of speech captured prior to receiving the trigger to generate a query-context speech vector. At Block 440, a retrieval agent large language model is applied to the query-context speech vector and the encoded speech vectors to generate a response vector. The response vector defines a response to the inferred query. The method also includes generating an output based on the response vector, at Block 450; and, at Block 460, presenting the output.

In some embodiments, the trigger is a user holding down a trigger key, e.g., on a wireless keyboard, during which they voiced out their query. The query ends when the key is released. For queryless mode, the trigger may be invoked by a single press on the trigger key. The trigger key can be included as a ring button for mobile settings.

In other embodiments, the query agent can communicate with the retrieval agent using any suitable data structure for the speech, for example, a text string, an encoded vector, etc. Both agents can independently use LLMs and vector encoding for their respective functions. In further embodiments, the query agent and the retrieval agent may use the same encoding for vectors.

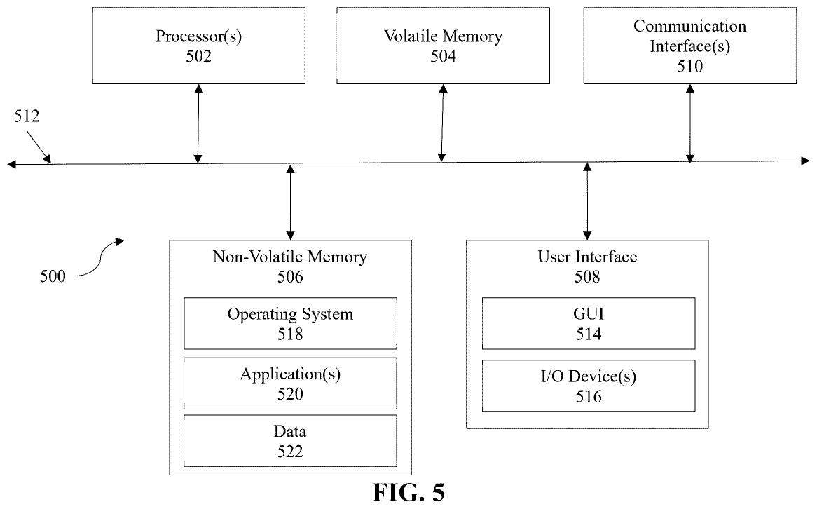

FIG. 5 is a block diagram illustrating selective components of an illustrative computing device 500 in which various aspects of the disclosure may be implemented, in accordance with an embodiment of the present disclosure. For instance, user devices 110 and/or server 140 of FIG. 1A can be substantially similar to computing device 500. As shown, computing device 500 includes processor(s) 502, a volatile memory 504 (e.g., random access memory, RAM), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described with reference to FIGS. 1B and 11). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor(s) 502 may be analog, digital or mixed signal. In some embodiments, processor(s) 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 500 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

Various embodiments of the concepts, systems, devices, structures and techniques sought to be protected are described. It should, however, be appreciated that alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Use of ordinal terms such as “first,” “second,” “third,” etc., in the claims to modify a claim clement does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A system for context-based query modeling, the system comprising:
an input device to provide a textual representation of speech;
a memory encoder for generating encoded speech data structures based on the textual representation of speech;
a query agent for generating a query-context speech data structure encoding a segment of the textual representation of speech;
a retrieval agent for generating a response based on the query-context speech data structure and the encoded speech data structures, the response defining a response to the query-context speech data structure; and
an output device for presenting the response.

2. The system of claim 1, wherein the input device includes:
a. a microphone to generate audio data responsive to the speech; and
b. a speech-to-text converter to generate the textual representation of the speech from the audio data.

3. The system of claim 1, wherein the input device is configured to detect a conversation has begun and, in response to the conversation having begun, to generate audio data responsive to the speech in the conversation.

4. The system of claim 1, wherein the input device is configured to detect the conversation has ended and, in response to the conversation having ended, to cease generating audio data.

5. The system of claim 1, wherein the output device includes:
a. a text-to-speech converter to generate audio data encoding the response, and
b. a device for converting the audio data to sound.

6. The system of claim 5, wherein the device for converting the audio data to sound is one of:
a bone conduction device and a speaker.

7. The system of claim 1, wherein the system is configured to convert the response to a text message, and
wherein the output device further comprises a display configured to show the text message.

8. The system of claim 1, further comprising a current context buffer configured to store a threshold number of recent encoded speech data structures, wherein the query agent generates the query-context speech data structure encoding based at least in part on the recent encoded speech data structures stored in the current context buffer.

9. A method for context-based query modeling, the method comprising:
monitoring a conversation comprising speech data by applying a first large language model to generate encoded speech data structures;
receiving a trigger requesting a response to an inferred query;
applying, by a query agent, a second large language model to a segment of speech captured prior to receiving the trigger to generate a query-context speech data structure;
applying, by a retrieval agent, a third large language model to the query-context speech data structure and the encoded speech data structures to generate a response, the response defining the response to the inferred query;
generating an output based on the response; and
presenting the output.

10. The method of claim 9, wherein presenting the output includes displaying a text response message on at least one of:
a. a phone screen;
b. a smart watch screen; and
c. a smart glasses display.

11. The method of claim 9, further comprising applying a text-to-speech converter to the response in order to generate an audio response message.

12. The method of claim 11, wherein presenting the output includes playing the audio response message on at least one of:
a. a phone speaker;
b. a smart watch speaker;
c. an earpiece; and
d. bone conduction headset.

13. The method of claim 9, wherein applying the third large language model to generate a response includes applying the third large language model to historic encoded speech data structures, wherein the historic encoded speech data structures were generated from speech captured in a prior conversation.

14. The method of claim 9, further comprising collecting context data by determining at least one of:
a. a location of the conversation; and
b. a time of day of the conversation, wherein applying the third large language model to generate a response includes applying the third large language model to the context data.

15. The method of claim 9, further comprising collecting physiological data of a speaker in the conversation by determining at least one of:
a. a heart rate; and
b. blood oxygen levels,
wherein applying the third large language model to generate a response includes applying the third large language model to the physiological data.

16. The method of claim 9, wherein the trigger is one of:
a. a command word; and
b. a button press.

17. The method of claim 9, wherein the segment of speech captured prior to receiving the trigger comprises a sentence fragment, and wherein the response completes the sentence fragment.

18. The method of claim 9, wherein the segment of speech captured prior to receiving the trigger comprises a question, and wherein the response answers the question.

19. The method of claim 9, further comprising processing the response to remove any words found in the segment of speech captured prior to receiving the trigger.

20. The method of claim 9, wherein the conversation is a text-based exchange, and the speech data is string of text from the text-based exchange.
